(19) United States
(12) Patent Application Publication
(10) Pub. No.: US 2016/0224701 A1
(43) Pub. Date: Aug. 4, 2016

(54) DESIGN VALIDATION SYSTEM

(71) Applicant: Samsung Electronics Co., Ltd., Suwon-si (KR)

(72) Inventors: Seok Ryul Kim, Hwaseong-si (KR); Bang Weon Lee, Yongin-si (KR)

(21) Appl. No.: 14/987,136

(22) Filed: Jan. 4, 2016

(30) Foreign Application Priority Data
Feb. 4, 2015 (KR) 10-2015-0017205

(51) Int. Cl. G06F 17/50

(52) U.S. Cl. CPC G06F 17/5009; G06F 17/5081

(57) ABSTRACT

A design validation system including a plurality of design validation devices receiving design data from a user and performing a simulation process to validate at least one of a plurality of product characteristics calculated from the design data and a simulation management device having simulation information about the characteristics required for a performance of the simulation process and transmitting the simulation information to the design validation devices upon request by the plurality of design validation devices, wherein the plurality of design validation devices simultaneously perform the simulation processes to validate the product characteristics.

### CROSS-REFERENCE TO RELATED APPLICATION

This U.S. non-provisional application claims the benefit of priority under 35 U.S.C. §119 to Korean Patent Application No. 10-2015-0017205 filed on Feb. 4, 2015, with the Korean Intellectual Property Office, the disclosure of which is incorporated herein in its entirety by reference.

### BACKGROUND

Various example embodiments of the present inventive concepts relate to a design validation system.

Semiconductor light emitting devices, such as light emitting diodes (LEDs), have been used for a variety of applications, thanks to great product characteristics thereof, such as low energy consumption, high levels of brightness, relatively long service life, and the like. In using a semiconductor light emitting device as a light source, product characteristics of the semiconductor light emitting device, such as light output, light efficiency, heat radiation, stress, and the like should be predicted or estimated.

In order to validate the aforementioned product characteristics of a semiconductor light emitting device, a sample of the semiconductor light emitting device may be produced, based on design data provided by an engineer, and then power may be applied to the sample of the light emitting device, such that the product characteristics of the sample light emitting device, such as light output, light efficiency, heat radiation, stress, and the like may be measured. However, many resources, such as employee time and money, are consumed in producing the sample, and in the case in which the design of the semiconductor light emitting device is changed, a new sample needs to be produced in order to validate the product characteristics of the new sample.

### SUMMARY

An aspect of the present inventive concepts may provide a design validation system able to virtually validate a product to be manufactured, by performing a simulation process based on design data transmitted by a user, such that the efficiency of the design validation process may be improved, as for example, a plurality of design validation devices simultaneously perform simulation processes for one or more characteristics of the product.

According to an aspect of the present inventive concepts, a design validation system may include a plurality of design validation devices each configured to receive design data and perform at least one simulation process to validate at least one of a plurality of product characteristics calculated from the design data, a simulation management device configured to save simulation information associated with a performance of the simulation process according to the at least one of the plurality of product characteristics and transmit the simulation information to at least one of the plurality of design validation devices when receiving a request from the at least one of the plurality of design validation devices, and the plurality of design validation devices are each configured to perform simulation processes to validate the at least one of the plurality of product characteristics.

According to at least one example embodiment, the design validation system may include wherein the plurality of design validation devices are configured to simultaneously perform the simulation processes to validate desired product characteristics among the plurality of product characteristics.

According to at least one example embodiment, the design validation system may include the simulation management device is configured to allocate the simulation processes to the plurality of design validation devices depending on a workload of each design validation device, and the workload of each design validation device is determined based on the simulation processes currently being performed or standing by in the queue associated with each of the plurality of respective design validation devices.

According to at least one example embodiment, the design validation system may include wherein the design data includes design data for at least one product of a light emitting device and a light emitting device package.

According to at least one example embodiment, the design validation system may include wherein the design data includes at least one of structure data of the product, material property data contained in the product, and power data applied to the product.

According to at least one example embodiment, the design validation system may include wherein the plurality of product characteristics include at least two of structural stress of the product, structural deformation of the product, heat radiation of the product, and light output of the product.

According to at least one example embodiment, the design validation system may include wherein the design data includes Standard for the Exchange of Product Model (STEP) data.

According to at least one example embodiment, the design validation system may include wherein the STEP data is provided as at least one of an AP203 file and an AP214 file.

According to at least one example embodiment, the design validation system may include wherein the design validation devices are each configured to extract data required for a validation of the at least one of the plurality of product characteristics from the STEP data, and validate the at least one of the plurality of product characteristics based on the extracted data and the simulation information.

According to at least one example embodiment, the design validation system may include wherein the simulation information includes at least one of a software module, the software module including the simulation process, and input parameter information for the product characteristics to be validated by the simulation process.

According to at least one example embodiment, the design validation system may include wherein the design validation device is configured to compile program source code included in the software module and perform the simulation process.

According to at least one example embodiment, the design validation system may include wherein the plurality of design validation devices and the simulation management device are included in at least one server.

According to at least one example embodiment, the design validation system may include wherein the design validation devices are each configured to manage result data calculated by performing the simulation process based on the simulation information transmitted by the simulation management device, according to the unique IDs.

According to an aspect of the present inventive concepts, at least one example embodiment may provide a design validation system configured so that a user can input a design drawing thereto. The design validation system may include a computing device configured to receive a design drawing input through the computing device, and convert the design drawing into design data, a plurality of design validation devices configured to receive the design data from the computing device and perform a simulation process to validate at least one of a plurality of product characteristics calculated from the design data, the computing device configured to determine the allocation of the design data to at least one of the plurality of design validation devices according to a workload of each of the plurality of design validation devices, and the workload is determined based on simulation processes currently being performed or standing by in queues of each of the plurality of respective design validation devices.

Here, the computing device may allocate the design data to the plurality of design validation devices according to a workload of each design validation device, and the workload is determined based on simulation process currently being performed or standing by in the queue for the plurality of respective design validation devices.

According to an aspect of the present inventive concepts, a design validation device may be provided that may include a data receiver configured to receive from at least one external device design information indicating a product design drawing and simulation information indicating at least one product characteristic to be validated, a data transmitter configured to transmit workload information related to the device's current workload to the external device, and a simulation calculator configured to generate validation results based on the design information and the simulation information and to store the validation results in a memory.

According to at least one example embodiment, the design validation device may include the simulation information received from the external device includes a simulation process for virtually validating the at least one product characteristic, and the simulation calculator is configured to generate the validation results by compiling and executing the simulation process and using the simulation process to virtual validate the device design information.

According to at least one example embodiment, the design validation device may include wherein the data transmitter is configured to transmit the generated validation results to the external device.

According to at least one example embodiment, the design validation device may include a data converter configured to convert the received design information into a file format compatible with the simulation calculator.

According to at least one example embodiment, the design validation device may include wherein the data transmitter is configured to receive additional design information and simulation information from the external device in response to the transmitted workload information.

### BRIEF DESCRIPTION OF DRAWINGS

The foregoing and other features of inventive concepts will be apparent from the more particular description of non-limiting example embodiments of inventive concepts, as illustrated in the accompanying drawings in which like reference characters refer to like parts throughout the different views. The drawings are not necessarily to scale, emphasis instead being placed upon illustrating principles of inventive concepts. In the drawings:

FIG. 1 is an exemplary view illustrating a design validation system according to at least one example embodiment;

FIG. 2 is a block diagram illustrating a design validation device which may be included in the design validation system according to at least one example embodiment;

FIG. 3 is a block diagram illustrating a simulation management device which may be included in the design validation system according to at least one example embodiment;

FIGS. 4 and 5 are block diagrams illustrating the design validation system according to at least one example embodiment;

FIG. 6 is a flow diagram illustrating an operation of the design validation system according to at least one example embodiment;

FIGS. 7 to 12 are views illustrating a semiconductor light emitting device which may be virtually validated by the design validation system according to at least one example embodiment; and

FIG. 13 to FIG. 15 are views illustrating a semiconductor light emitting device package which may be virtually validated by the design validation system according to at least one example embodiment.

### DETAILED DESCRIPTION

Various example embodiments will now be described more fully with reference to the accompanying drawings, in which some example embodiments are shown. Example embodiments, may, however, be embodied in many different forms and should not be construed as being limited to the embodiments set forth herein; rather, these example embodiments are provided so that this disclosure will be thorough and complete, and will fully convey the scope of example embodiments of inventive concepts to those of ordinary skill in the art. In the drawings, the thicknesses of layers and regions are exaggerated for clarity. Like reference characters and/or numerals in the drawings denote like elements, and thus their description may be omitted.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements or layers should be interpreted in a like fashion (e.g., “between” versus “directly between,” “adjacent” versus “directly adjacent,” “on” versus “directly on”). As used herein the term “and/or” includes any and all combinations of one or more of the associated listed items.

It will be understood that, although the terms referred to as being “connected” or “coupled” to scribe various elements, components, regions, layers and/or sections. These elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 90 degrees or at other orientations) and the spatially relative descriptors used herein interpreted accordingly.

Although corresponding plan views and/or perspective views of some cross-sectional view(s) may not be shown, the cross-sectional view(s) of device structures illustrated herein provide support for a plurality of device structures that extend along two different directions as would be illustrated in a plan view, and/or in three different directions as would be illustrated in a perspective view. The two different directions may or may not be orthogonal to each other. The three different directions may include a third direction that may be orthogonal to the two different directions. The plurality of device structures may be integrated in a same electronic device. For example, when a device structure (e.g., a memory cell structure or a transistor structure) is illustrated in a cross-sectional view, an electronic device may include a plurality of the device structures (e.g., memory cell structures or transistor structures), as would be illustrated by a plan view of the electronic device. The plurality of device structures may be arranged in an array and/or in a two-dimensional pattern.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises”, “comprising”, “includes” and/or “including,” if used herein, specify the presence of stated features, integers, steps, operations, elements and/or components, but do not preclude the presence or addition of one or more other features, integers, steps, operations, elements, components and/or groups thereof. Expressions such as “at least one of,” when preceding a list of elements, modify the entire list of elements and do not modify the individual elements of the list.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. For example, an implanted region illustrated as a rectangle may have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of example embodiments.

Unless otherwise defined, all terms (including technical and scientific terms) used herein have the same meaning as commonly understood by one of ordinary skill in the art to which example embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

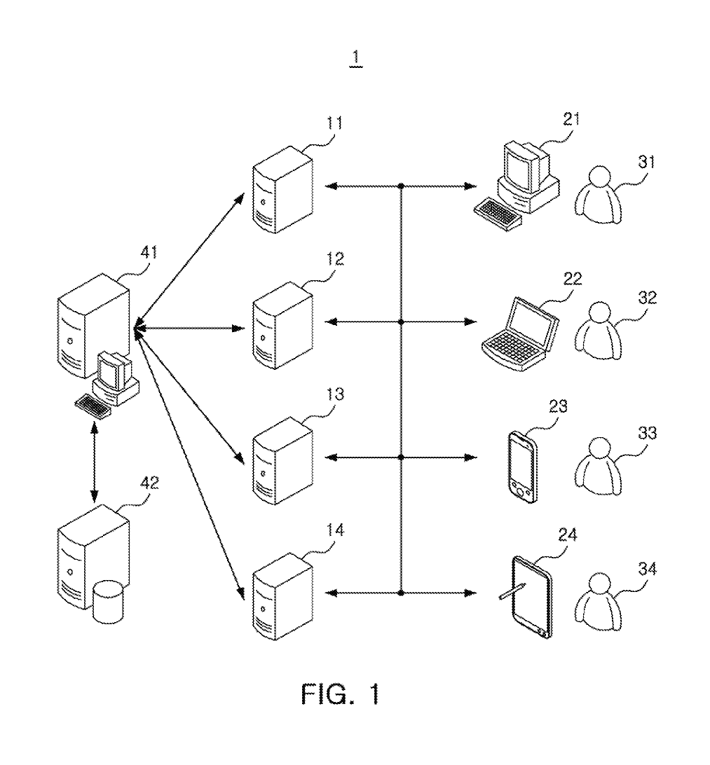

FIG. 1 is an example view illustrating a design validation system according to at least one example embodiment of the present inventive concepts.

Referring to FIG. 1, a design validation system 1 may include design validation devices 11 to 14 applying design data to a simulation process and virtually validating characteristics of a product to be manufactured based on the design data. The design validation system 1 may also include simulation management devices 41 and 42 connected to the design validation devices 11 to 14 so as to communicate therewith and provide simulation information desired, useful for, and/or necessary for the performance of the simulation processes, and the like. Each of the design validation devices 11 to 14 and each of the simulation management devices 41 and 42 may be provided as one or more servers, and the simulation management devices 41 and 42 may include a management server 41, a database server 42, and the like.

The design validation system 1 may include the plurality of design validation devices 11 to 14, and each of the design validation devices 11 to 14 may be connected to at least one of user terminals 21 to 24. In FIG. 1, the design validation system 1 is illustrated as having four design validation devices 11 to 14, but is not limited thereto.

The design validation devices 11 to 14 may be connected to the user devices 21 to 24, and the user devices 21 to 24 may be provided in a variety of forms, such as a personal computer (PC) 21, a laptop computer 22, a smartphone 23, a tablet PC 24, a wearable smart device, a gaming console, a smart appliance, and the like. One or more users 31 to 34 may input design data of a specific product into various user devices 21 to 24. The design data input by the users 31 to 34 may include a file generated by computer aided design (CAD) program, computer aided manufacturing (CAM) program, and/or other software program. In detail, the users 31 to 34 may input a file including design data for manufacturing a specific product into the user devices 21 to 24.

The user devices 21 to 24 may directly transmit a file input by a user to the design validation devices 11 to 14, or transmit design data of a product to the design validation devices 11 to 14 after extracting the design data from a file input by a user. For example, the user devices 21 to 24 may convert a file input by a user in CAD format, CAM format, etc., into STEP AP203 data, STEP AP214 data, or the like.

The STEP data is data according to the International Organization for Standardization (ISO), a file format defined for data exchange between a CAD system and a CAM system. AP203 and AP214, among STEP data file formats, are formats able to define information, shape, and the like of a mechanical component or a product. The design data of the AP203 format may include product information, line, face, composite surface, three-dimensional shape, assembly, and the like. The design data of AP214 format may include information about color, layer, and the like, as well as product information, line, face, composite surface, three-dimensional shape, and assembly.

A conversion process of design data into STEP data from a file input by a user may be performed by the user devices 21 to 24 or the design validation devices 11 to 14. In a case in which the user devices 21 to 24 convert the design data, each of the user devices 21 to 24 may include a module for the conversion of the design data, and the module may be provided in the form of a software program.

The user devices 21 to 24 may allocate the design data to each of the design validation devices 11 to 14 based on simulation processes currently being performed in the respective design validation devices 11 to 14. As illustrated in FIG. 1, each of the user devices 21 to 24 may be connected to the plurality of design validation devices 11 to 14 so as to communicate therewith, and may transmit the design data to at least one of the desired design validation devices 11 to 14, for example the design validation device having the lowest workload among the design validation devices 11 to 14.

The design validation devices 11 to 14 receiving the design data from the user devices 21 to 24 may simulate one of the plurality of product characteristics calculated from the design data. Here, a simulation may be performed using the design data for manufacturing the product, without using a real product such as a product sample, prototype, or the like. In detail, based on the design data, the design validation devices 11 to 14 may virtually validate characteristics of the product to be manufactured, based on corresponding design data.

For example, in a case in which design data received by the design validation devices 11 to 14 is design data about a semiconductor light emitting device package, the design data may include data about reflexibility of a reflective surface disposed in the semiconductor light emitting device package, a range of power applied to the semiconductor light emitting device included in the package and light output thereof, area and material of a heat radiation unit of the package, and the like. The design validation devices 11 to 14 may virtually validate product characteristics of the semiconductor light emitting device package, such as light output, efficiency, heat radiation, and the like, by simulating the product characteristics based on the design data.

A simulation process, simulation information, and the like may be desired, useful for, and/or required so that product characteristics such as light output, efficiency, heat radiation, and the like may be virtually validated by the design validation devices 11 to 14. The simulation process may be a software program able to calculate a result value of virtual validation of at least one product characteristic based on design data received from the user devices 21 to 24. The simulation information may include input parameter information desired, useful for, and/or required for a performance of a simulation process.

According to at least one example embodiment of the present inventive concepts, the simulation information may be stored in the simulation management devices 41 and 42 connected to the design validation devices 11 to 14 so as to communicate therewith. The design validation devices 11 to 14 may receive design data from the user devices 21 to 24, and when a product characteristic to be virtually validated is determined, the design validation devices 11 to 14 may request simulation information desired, useful for, and/or required for performing a simulation process validating the product characteristic and receive the simulation information from the simulation management devices 41 and 42. The simulation information transmitted by the simulation management devices 41 and 42 may be assigned a desired (and/or alternatively predetermined) ID and managed together with the design data transmitted by the user devices 21 to 24. The ID assigned to the simulation information may be a unique ID that indicates the simulation management device and/or design validation device that the simulation information is associated with.

For example, in a case in which the design validation devices 11 to 14 virtually validate light output characteristic of a semiconductor light emitting device package by using design data thereof, the design validation devices 11 to 14 may request a service specification to calculate the light output of the semiconductor light emitting device package from the simulation management devices 41 and 42. Here, the service specification requested by the design validation devices 11 to 14 may be included in the simulation information. According to at least one example embodiment of the present inventive concepts, the design validation devices 11 to 14 may compile the simulation information provided in the form of a software module and perform simulation processes to virtually validate the light output characteristic of the semiconductor light emitting device package.

The design validation devices 11 to 14 may calculate the light output value of the semiconductor light emitting device package to be manufactured from the design data, by applying ranges of voltage and current applied to the semiconductor light emitting device package, operation efficiency thereof, reflexibility of a reflective surface thereof, and the like to the simulation processes. Since product characteristics of semiconductor light emitting device packages may be validated without producing a semiconductor light emitting device package, time and cost required to validate the product characteristics thereof may be reduced.

Referring to FIG. 1, the plurality of design validation devices 11 to 14 may individually, concurrently, and/or simultaneously receive design data from the plurality of user devices 21 to 24. Each of the user devices 21 to 24 may be controlled to transmit the design data to a desired design validation device having desired characteristics, such as having relatively the lowest workload of simulation processes, the most resources available for the simulation processes, etc. In addition, since simulation processes of at least one of the plurality of product characteristics to be calculated from the design data may be simultaneously performed in two or more design validation devices 11 to 14, time and resources required for the virtual validation may be improved, increased, and/or optimized.

For example, in a case in which the light output characteristic and heat radiation characteristic are virtually validated from design data of the semiconductor light emitting device package, a first design validation device 11 may validate the light output characteristic, and a fourth design validation device 14 may validate the heat radiation characteristic, individually, concurrently, and/or simultaneously. In addition, in a case in which light output characteristic is virtually validated when different levels of power are applied, the first design validation device 11 and a second design validation device 12 may perform virtual validation processes using different levels of power applied thereto.

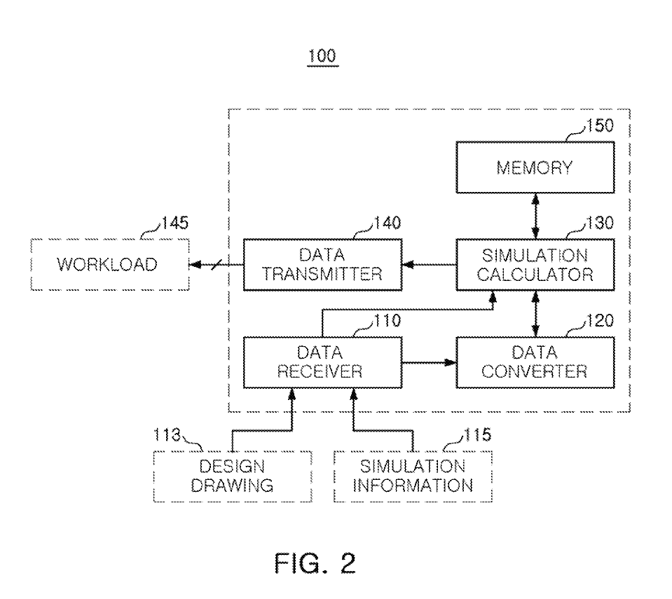

FIG. 2 is a block diagram illustrating a design validation device which may be included in a design validation system according to at least one example embodiment of the present inventive concepts.

Referring to FIG. 2, a design validation device 100 may include a data receiver 110, a data converter 120, a simulation calculator 130, a data transmitter 140, and a memory 150. The data converter 120 may convert data received by the data receiver 110 so that the simulation calculator 130 may interpret the data. According to at least one example embodiment of the present inventive concepts, in a case in which data is received by the data receiver 110 in the format able to be interpreted by the simulation calculator 130, the data may be transmitted to the simulation calculator 130 directly, without passing through the data converter 120.

The data receiver 110 may be connected so as to communicate with an external device, and according to at least one example embodiment of the present inventive concepts, the data receiver 110 may receive a design drawing 113 and simulation information 115. The data receiver 110 may receive the design drawing 113 and the simulation information 115, respectively, from an external server and/or a user device connected so as to communicate with the design validation device 100. The external server may be the simulation management devices 41 and 42 in FIG. 1.

The design drawing 113 may be provided as a file produced by software programs and/or design tools such as CAD, CAM, and the like. In order to virtually validate a characteristic of a product to be manufactured with the design drawing 113, the data converter 120 may convert a file based on programs such as CAD, CAM, and the like into data which the simulation calculator 130 may be able to interpret. According to at least one example embodiment of the present inventive concepts, the data converter 120 may convert the design drawing 113 into STEP data of the AP203 format, AP214 format, or the like, to produce design data.

The simulation information 115 may be a program module including a simulation process virtually validating a characteristic of a product to be manufactured with the design drawing 113 and the like. The simulation calculator 130 may compile program source code of a program module included in the simulation information 115, to perform the simulation process, and virtually validate at least one of the product characteristics which may be calculated from design data, by applying the design data converted into the STEP data to the performed simulation process.

The data transmitter 140 may transmit workload 145 of the design validation device 100 to an external device. The workload 145 can be determined based on the simulation process currently being performed or standing by in the queue for the design validation device 100. The external device receiving the workload 145 may be the user devices 21 to 24 or the simulation management devices 41 and 42 in FIG. 1. According to at least one example embodiment of the present inventive concepts, the user devices 21 to 24 may display the workload 145 transmitted by the design validation device 100 so that the users 31 to 34 may be able to select which of the design validation devices to transmit the design drawing 113 to, such as the design validation device having the lowest workload 145 thereamong.

The simulation calculator 130 may give IDs to simulation information transmitted by the simulation management devices 41 and 42, a simulation process extracted from the simulation information, design data applied to the simulation process, and the like, and store the simulation information, the simulation process, the design data, and the like in the memory 150. The IDs may be provided when the users 31 to 34 access the design validation device 100 through the user devices 21 to 24 to search for desired, useful, and/or required virtual validation data. The ID assigned to the simulation information may be a unique ID that indicates the simulation management device and/or design validation device that the simulation information is associated with.

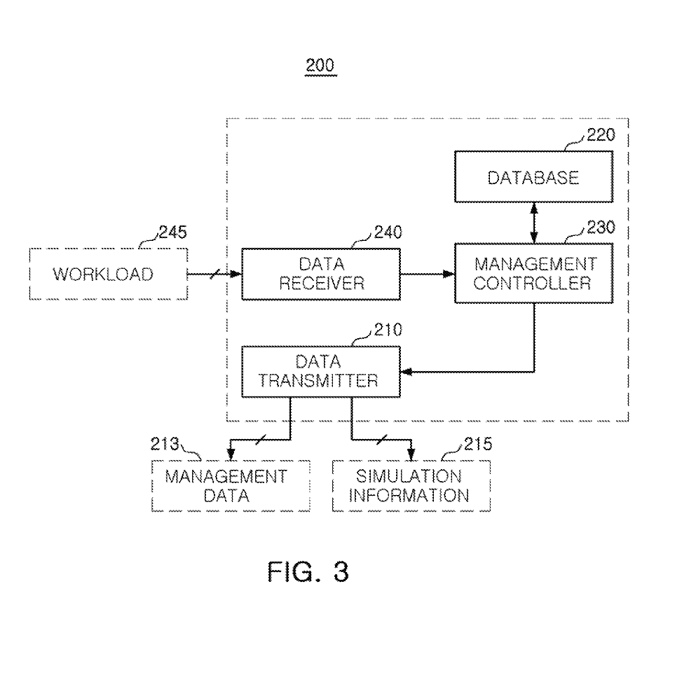

FIG. 3 is a block diagram illustrating a simulation management device which may be included in the design validation system according to at least one example embodiment of the present inventive concepts.

Referring to FIG. 3, a simulation management device 200 may include a data transmitter 210, a database 220, a management controller 230, and a data receiver 240.

The data transmitter 210 may externally transmit management data 213, simulation information 215, and the like transmitted from the management controller 230. The management data 213 may be data having workload information of a simulation process currently being performed by the design validation device 100 connected to the simulation management device 200. The management data 213 may be transmitted to the user devices 21 to 24 of FIG. 1. The user devices 21 to 24 may analyze the workload of the design validation device 100 using the management data 213 and transmit a design drawing or design data for a virtual validation of a product characteristic to a design validation device 100 having the lowest workload thereamong.

The simulation information 215 may include data desired, useful for, and/or required when the design validation device 100 performs a simulation process. For example, the simulation information 215 may include an input parameter of a product characteristic to be virtually validated, an output parameter calculated from the input parameter of a relevant product characteristic, a program able to receive the input parameter and calculate the output parameter, and the like. According to at least one example embodiment of the present inventive concepts, the program may be included in the simulation information 215 in a form of a source code to be provided, and may be compiled by the design validation device 100 to be performed as a simulation process.

The data receiver 240 may receive a workload 245 from the design validation device 100. A single simulation management device 200 may be connected to a plurality of the design validation devices 100 in parallel or in series, and the data receiver 240 may receive the workload 245 corresponding to tasks of simulation processes currently being performed or standing by in the queues for each of the plurality of design validation devices 100. The management controller 230 may analyze the workload 245 received from the data receiver 240 and transmit the management data 213 through the data transmitter 210. The management data 213 may be transmitted to the user devices 21 to 24 connected to the design validation devices 100 and used when the user devices 21 to 24 transmit a design drawing or design data to a design validation device 100 having the lowest workload thereamong.

The database 220 may include data required for maintenance and management of the design validation device 100. In FIG. 3, the database 220 has been illustrated to be included in the simulation management device 200, but the database 220 may be provided as a separate server and/or on an external device.

The database 220 may store the simulation information 215 required to virtually validate at least one of the characteristics of a product to be manufactured based on the design data. As described above, the simulation information 215 may include a software program corresponding to a simulation process performed for a virtual validation by the design validation device 100, the input/output parameter to be virtually validated using the simulation process, and the like.

For example, when the design validation device 100 virtually validates a product characteristic of a semiconductor light emitting device, the simulation information 215 may include a software program for a virtual validation of a heat radiation characteristic of the semiconductor light emitting device, alight output characteristic thereof, and the like. When it comes to a software program for validation of the heat radiation characteristic, the input parameter may include material property information of a material included in the semiconductor light emitting device, such as heat conductivity and the like, and the output parameter may include information regarding desired and/or expected performance values or performance results, such as a range of temperatures in which the semiconductor light emitting device may endure without being damaged, a heat resistance value, and the like. Once a request from the design validation device 100 for a virtual validation of the heat radiation characteristic of the semiconductor light emitting device is received, the simulation management device 200 may transmit the simulation information 215 for the virtual validation of the heat characteristic to the design validation device 100.

The design validation device 100 may calculate various characteristics of a product to be manufactured, such as heat conductivity, thermal expansity, and the like of a material contained in the semiconductor light emitting device as the input parameter, using the design data transmitted by the user terminals. The design validation device 100 may calculate result values such as the range of temperature in which the semiconductor light emitting device may endure without being damaged, a heat resistance value thereof, and the like by inputting a heat conductivity value, heat expansion value, etc. as input parameters into a simulation process included in the simulation information 215 transmitted by the simulation management device 200.

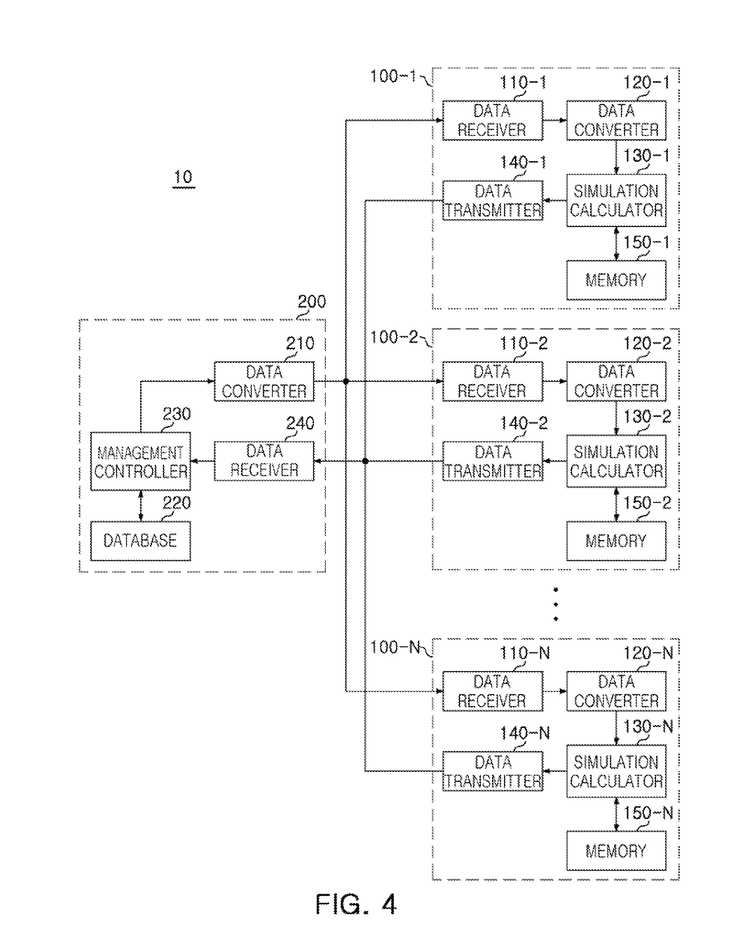

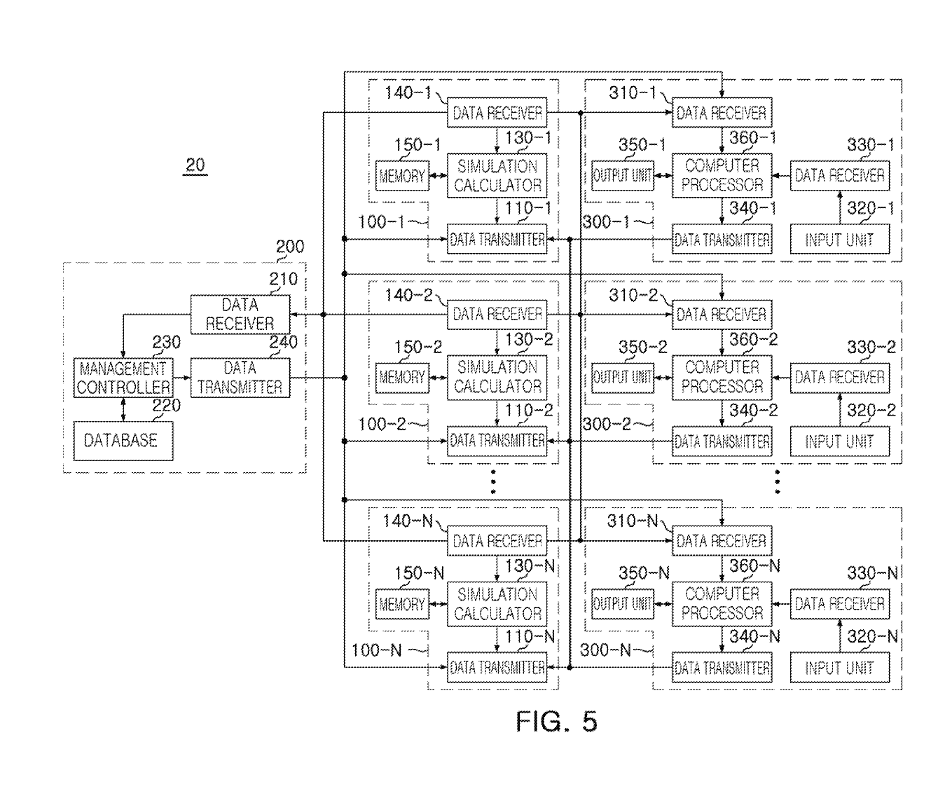

FIG. 4 and FIG. 5 are block diagrams illustrating a design validation system according to at least one example embodiment of the present inventive concepts.

First, referring to FIG. 4, a design validation system 10 according to at least one example embodiment of the present inventive concepts may include a plurality of design validation devices 100-1 to 100-N and a simulation management device 200. In FIG. 4, the design validation system 10 has been illustrated to include a single simulation management device 200, but a plurality of simulation management devices 200 may be included in the design validation system 10. Each of the plurality of design validation devices 100-1 to 100-N may include a data receiver 110-1, 110-2, or 110-N, a data converter 120-1, 120-2, or 120-N, a simulation calculator 130-1, 130-2, or 130-N, a data transmitter 140-1, 140-2, or 140-N, a memory 150-1, 150-2, or 150-N, and the like. Respective functions of units included in the plurality of design validation devices 100-1 to 100-N may be similar with respective functions of units included in the design validation device 100 illustrated in FIG. 2.

Referring to FIG. 4, the plurality of design validation devices 100-1 to 100-N may be connected to the simulation management device 200 in parallel or in series. Accordingly, data transmitted by a data transmitter 210 of the simulation management device 200 may be individually, concurrently, and/or simultaneously received by the plurality of design validation devices 100-1 to 100-N. Data transmitted by the data transmitters 140-1 to 140-N of the plurality of design validation devices 100-1 to 100-N may be received by a data receiver 240 of the simulation management device 200. The data transmitters 140-1 to 140-N of the plurality of design validation devices 100-1 to 100-N may transmit a workload corresponding to the tasks of a simulation process currently being performed or standing by in the queues for the design validation devices 100-1 to 100-N to the simulation management device 200. Thus, the simulation management device 200 may be able to collectively manage respective workloads of the design validation devices 100-1 to 100-N.

A management controller 230 of the simulation management device 200 may retrieve simulation information stored in a database 220 and transmit the simulation information to the respective design validation devices 100-1 to 100-N. Here, identical simulation information or different simulation information may be transmitted to the respective design validation devices 100-1 to 100-N. Thus, each of the design validation devices 100-1 to 100-N may be able to concurrently and/or simultaneously perform simulation processes virtually validating a single product characteristic or two or more different product characteristics in parallel, thereby improving efficiency of the design validation system 10. Additionally, the design validation devices 100-1 to 100-N may be able to perform simulation processes virtually validating one or more product characteristics individually. In addition, a new design validation device may be easily added if necessary, such that the design validation system 10 may be easily maintained.

Referring to FIG. 5, a design validation system 20 according to at least one example embodiment of the present inventive concepts may include a plurality of design validation devices 100-1 to 100-N, a simulation management device 200, and a plurality of user devices 300-1 to 300-N. As illustrated above with reference to FIG. 1, the user devices 300-1 to 300-N may include a wide variety of devices able to perform a software program, such as a desktop computer, a laptop computer, a smartphone, a tablet PC, a wearable smart device, a smart appliance, a gaming console, and the like.

The user devices 300-1 to 300-N may be connected so as to communicate with the design validation devices 100-1 to 100-N and the simulation management device 200 through wire/wireless communications networks. In the example embodiment of FIG. 5, each of the user devices 300-1 to 300-N has been illustrated to be connected to a single design validation device, but is not limited thereto. In detail, each of the user devices 300-1 to 300-N may be connected to the plurality of design validation devices 100-1 to 100-N, or each of the design validation devices 100-1 to 100-N may be connected to the plurality of the user devices 300-1 to 300-N. Additionally, there may be a single user device that is connected to one or more design validation devices.

According to at least one example embodiment of the present inventive concepts concept in FIG. 5, once a user inputs a design drawing through one or more of input units 320-1 to 320-N, data converter 330-1 to 330-N may convert the design drawing into design data to be used for virtual validation. According to at least one example embodiment of the present inventive concepts, once the user inputs a design drawing made using a CAD program, a CAM program, etc., the data converters 330-1 to 330-N may convert the design drawing into STEP data of AP203 format, AP214 format, or the like. The STEP data may be provided, as design data, to the design validation devices 100-1 to 100-N. Thus, according to the example embodiment illustrated in FIG. 5, the design validation devices 100-1 to 100-N may not include the data converter, unlike in FIG. 2 and FIG. 4.

Computer processors 360-1 to 360-N may determine a design validation device to receive design data, based on management data transmitted by the simulation management device 200 through data receivers 310-1 to 310-N. According to at least one example embodiment of the present inventive concepts, in a case in which a simulation process is being performed in a first design validation device 100-1 and no simulation process is being performed in a second design validation device 100-2, the computer processors 360-1 to 360-N may transmit design data to be used for a virtual validation to the second design validation device 100-2. In a case in which simulation processes are being performed in all the design validation devices 100-1 to 100-N, the computer processors 360-1 to 360-N may transmit design data to be used for a virtual validation to a desired design validation device based on various criterion associated with the design validation devices, such as the design validation device having the smallest number of simulation processes standing by to be performed thereamong, or by selecting the design validation device with specialized performance capabilities, etc.

Operations of the design validation devices 100-1 to 100-N and the simulation management device 200 may be similar to operations of the design validation devices and the simulation management device illustrated in FIG. 4. For example, simulation calculators 130-1 to 130-N may request simulation information about a product characteristic to be virtually validated from the simulation management device 200, based on design data transmitted through the data receivers 110-1 to 110-N. The simulation management device 200 may transmit simulation information including a simulation process about a product characteristic to be virtually validated and input/output parameter information to the design validation devices 100-1 to 100-N. The simulation calculators 130-1 to 130-N may virtually validate product characteristics based on the design data and the simulation information.

As described above with reference to FIG. 4 and FIG. 5, the design validation systems 10 and 20 may not individually store simulation information required for the design validation devices 100-1 to 100-N to virtually validate a desired (and/or alternatively predetermined) product characteristic. The design validation devices 100-1 to 100-N may dynamically request required simulation information from the simulation management device 200 according to the design data transmitted by a user and a characteristic, to be virtually validated, of a product to be manufactured based on the design data. In addition, a plurality of simulation processes may be concurrently and/or simultaneously performed in parallel, by connecting the plurality of design validation devices 100-1 to 100-N in parallel. Thus, server resources included in the design validation systems 10 and 20 may be efficiently used. In addition, interference between the design validation devices 100-1 to 100-N may be significantly reduced, and in a case in which an additional design validation device is required, a new design validation device may be easily added without modifying complicated system software code. Thus, the design validation systems 10 and 20 may be efficiently maintained.

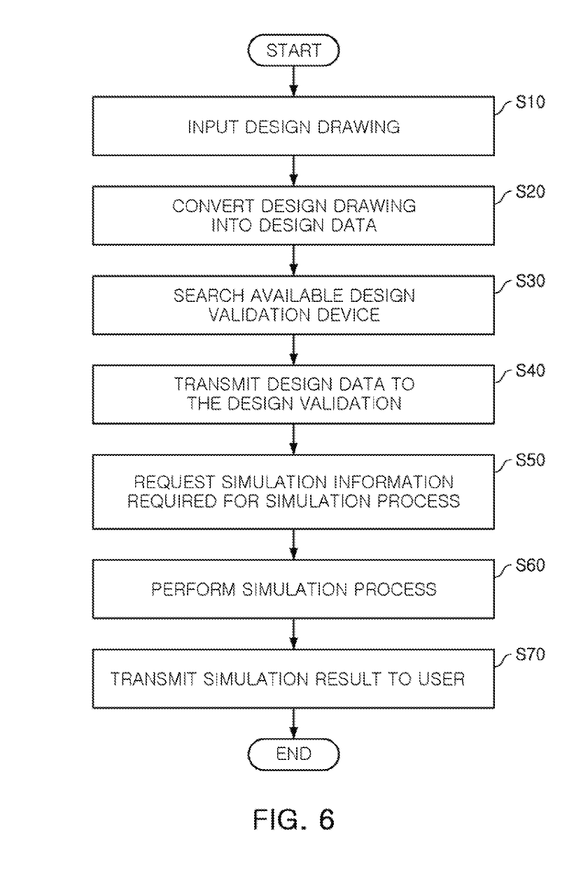

FIG. 6 is a flow diagram, illustrating operations of the design validation system according to at least one example embodiment of the present inventive concepts.

Referring to FIG. 6, the operations of the design validation system 20 according to at least one example embodiment of the present inventive concepts may start with an input of a design drawing by a user (S10). The operations illustrated in the flowchart in FIG. 6 may be applied to all the design validation systems 1, 10, and 20 illustrated in FIGS. 1 to 5. Hereinafter, for convenience in description, the operations of the flow diagram illustrated in FIG. 6 will be described with reference to the design validation system 20 in FIG. 5.

A user may input a design drawing through at least one of user terminals 300-1 to 300-N. The design drawing may be a drawing made by a software program and/or design tool such as CAD, CAM, or the like. The data converters 330-1 to 330-N of the user devices 300-1 to 300-N may convert the input drawing into design data to be used for a virtual validation (S20). The design data may be converted into STEP data according to a standard from International Organization for Standardization (ISO), and according to at least one example embodiment of the present inventive concepts, the design data may be converted into a file of AP203 format, AP214 format, or the like.

When the conversion of the design data is completed, the user devices 300-1 to 300-N may search for an available device from a plurality of design validation devices 100-1 to 100-N (S30). The workload of a simulation process currently being performed or standing by in the queue for the respective design validation devices 100-1 to 100-N may be managed by the simulation management device 200. The user devices 300-1 to 300-N may receive information about the workload of the respective design validation devices 100-1 to 100-N from the data transmitter 240 of the simulation management device 200, and search for an available design validation device based on the received information.

In order to improve operation efficiency of the design validation devices 100-1 to 100-N, the user devices 300-1 to 300-N may first search for a design validation device having the lowest workload of a simulation process currently being performed or standing by to be performed therein from the design validation devices 100-1 to 100-N. Thus, the plurality of design validation devices 100-1 to 100-N may concurrently and/or simultaneously perform virtual validations of different or identical design data in parallel, thereby improving efficiency of virtual validation.

When an available design validation device is searched by the design validation devices 100-1 to 100-N, the user devices 300-1 to 300-N may transmit the design data to the available design validation device (S40). The design validation device receiving the design data may virtually validate at least one product characteristic using the design data. In order to virtually validate the at last one product characteristic, the design validation device may request simulation information required for performing a simulation process virtually validating the design data (S50).

According to at least one example embodiment of the present inventive concepts, in a case in which design data transmitted to a design validation device from a user device is design data about a semiconductor light emitting device package, the design validation device may request simulation information required to validate at least one of the product characteristics of the semiconductor light emitting device package. The simulation information may include product characteristics to be validated using the design data such as light output, heat radiation, deformation occurring due to external force, or the like of the semiconductor light emitting device package. In addition, the simulation information may include a software module required to validate respective product characteristics of the semiconductor light emitting device package with the design data.

In a case in which a user wishes to virtually validate a light output characteristic of the semiconductor light emitting device package using the design data, the design validation device may request simulation information required to virtually validate the light output characteristic of the semiconductor light emitting device package. According to the request made by the design validation device, the simulation management device 200 may transmit the simulation information to the design validation device. The design validation device may perform a simulation process by compiling program source code included in the simulation information (S60).

The pieces of simulation information requested by the design validation devices 100-1 to 100-N may be assigned their own IDs so that they may be separately managed in the design validation devices 100-1 to 100-N. In addition, in order to improve efficiency of resource management of the design validation devices 100-1 to 100-N, a plurality of product characteristics, which may be virtually validated using a single design datum, may be virtually validated in two or more design validation devices 100-1 to 100-N individually, concurrently and/or simultaneously. When the plurality of product characteristics, which may be virtually validated using a single design datum, are virtually validated in two or more design validation devices 100-1 to 100-N simultaneously, concurrently, and/or individually, a result of a validated product characteristic may be gathered from one or more of the design validation devices 100-1 to 100-N and managed by any one of the simulation management device 200 and the two or more design validation devices 100-1 to 100-N. Here, the results of the validated product characteristics may be managed, based on the IDs allocated to the pieces of simulation information requested by the design validation device in S50.

The result of the virtual validation of the product characteristic performed during the simulation process may be stored in memories 150-1 to 150-N of the design validation devices 100-1 to 100-N, the database 220 of the simulation management device 200, external memory, or the like, and may be provided to the user through output units 350-1 to 350-N (S70). The user terminals 300-1 to 300-N may display the simulation result in a form of graphic data of two-dimensional (2D) or three-dimensional (3D).

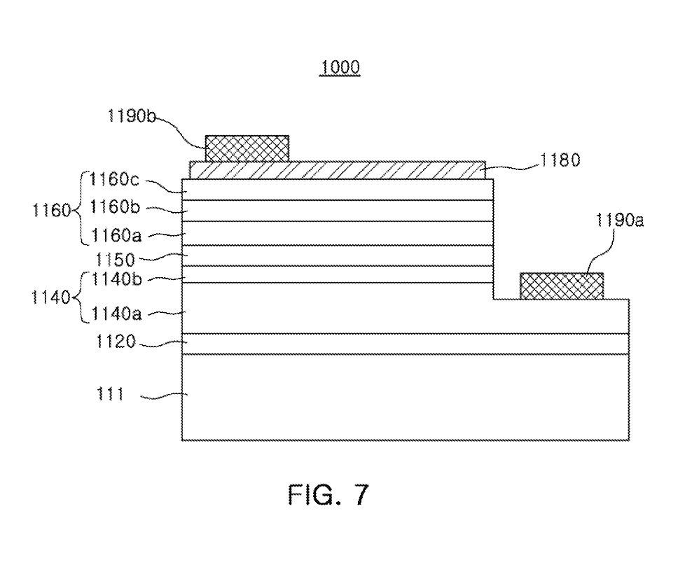

FIGS. 7 to 12 are views illustrating a semiconductor light emitting device which may be virtually validated by a design validation system according to at least one example embodiment of the present inventive concepts.

Referring to FIG. 7, a semiconductor light emitting device 1000 may include a substrate 1110, and a first conductivity-type semiconductor layer 1140, an active layer 1150, and a second conductivity-type semiconductor layer 1160 sequentially stacked on the substrate 1110. A buffer layer 1120 may be disposed between the substrate 1110 and the first conductivity-type semiconductor layer 1140.

The substrate 1110 may be an insulation substrate such as a sapphire substrate, but is not limited thereto, and the substrate 1110 may be a conductive substrate or a semiconductor substrate. For example, the substrate 1110 may be formed using SiC, Si, MgAl2O4, MgO, LiAlO2, LiGaO2, or GaN as well as sapphire.

The buffer layer 1120 may be an AlₓIn_{y}Ga_{(1-x-y)}N (0≦x≦1, 0≦y≦1) layer. For example, the buffer layer 1120 may be a GaN, AlN, AlGaN, or InGaN layer. If necessary, a plurality of combined layers or a layer of which a composition is gradually changed may also be used as the buffer layer 1120.

The first conductivity-type semiconductor layer 1140 may be a nitride semiconductor layer satisfying N-type InₓAl_{y}Ga_{1-x-y}N (0≦x<1, 0≦y<1, and 0≦x+y<1), and an N-type impurity may be silicon (Si). For example, the first conductivity-type semiconductor layer 1140 may include N-type GaN.

According to at least one example embodiment of the present inventive concepts, the first conductivity-type semiconductor layer 1140 may include a first conductivity-type semiconductor contact layer 1140a and a current diffusion layer 1140b. An impurity concentration of the first conductivity-type semiconductor contact layer 1140a may range from 2×10¹⁸ cm⁻³ to 9×10¹⁹ cm⁻³. A thickness of the first conductivity-type semiconductor contact layer 1140a may range from 1 μm to 5 μm. The current diffusion layer 1140b may have a structure in which a plurality of InₓAl_{y}Ga_{(1-x-y)}N (0≦x, y≦1, 0≦x+y≦1) layers of which compositions are different from each other or impurity content are different from each other are repeatedly stacked. For example, the current diffusion layer 1140b may be an N-type superlattice layer in which two or more layers including an N-type GaN layer and/or an InₓAl_{y}Ga_{(l-x-y)}N (0≦x, y≦1, 0≦x+y≦1) layer having a thickness of 1 nm to 500 nm and having different compositions from each other are repeatedly stacked. An impurity concentration of the current diffusion layer 1140b may range from 2×1018 cm⁻³ to 9×1019 cm⁻³. If necessary, an insulating material may be further contained in the current diffusion layer 1140b.

The second conductivity-type semiconductor layer 1160 may be a nitride semiconductor layer satisfying P-type InₓAl_{y}Ga_{1-x-y}N (0≦x<1, 0≦y<1, 0≦x+y<1), and a P-type impurity may be magnesium (Mg). For example, the second conductivity-type semiconductor layer 1160 may be implemented as a single-layer structure, but as described in at least one example embodiment of the present inventive concepts, may have a multi-layer structure. As illustrated in FIG. 7, the second conductivity-type semiconductor layer 1160 may include an electron-blocking layer (EBL) 1160a, a low-concentration P-type GaN layer 1160b, and a high-concentration P-type GaN layer 1160c provided as a contact layer. For example, the electron-blocking layer 1160a may have a structure in which a plurality of InₓAl_{y}Ga_{(1-x-y)}N (0≦x≦1, 0≦y≦1, 0≦x+y≦1) layers having a thickness ranging from 5 nm to 100 nm and having different compositions from each other are stacked, or a single-layer structure formed of Al_{y}Ga_{(1-y)}N (0<y≦1). An energy band gap Eg of the electron-blocking layer 1160a may decrease as a distance thereof from the active layer 1150 increases. For example, an Al composition of the electron-blocking layer 1160a may decrease as a distance of the electron-blocking layer 1160a from the active layer 1150 increases.

The active layer 1150 may have a multiple quantum well (MQW) structure in which a quantum well layer and a quantum barrier layer are alternately stacked. For example, the quantum well layer and the quantum barrier layer may be InₓAl_{y}Ga_{1-x-y}N (0≦x≦1, 0≦y≦1, 0≦x+y≦1) layers having different compositions from each other. In detail, the quantum well layer may be an InₓGa₁₋ₓN (0<x≦1) layer, and the quantum barrier layer may be a GaN layer or an AlGaN layer. Each thickness of the quantum well layer and the quantum barrier layer may range from 1 nm to 50 nm. A structure of the active layer 1150 is not limited to the multiple quantum well structure and may be a single quantum well structure.

The semiconductor light emitting device 1000 may include a first electrode 1190a disposed on the first conductivity-type semiconductor layer 1140, and an ohmic-contact layer 1180 and a second electrode 1190b sequentially disposed on the second conductivity-type semiconductor layer 1160.

The first electrode 1190a may include a material such as Ag, Ni, Al, Cr, Rh, Pd, Ir, Ru, Mg, Zn, Pt, Au, and the like, but is not limited thereto. The first electrode 1190a may be adopted as a single-layer structure or a multi-layer structure, and may further include a pad electrode layer thereon. The pad electrode layer may be a layer containing at least one of materials such as Au, Ni, Sn, and the like.

The ohmic-contact layer 1180 may be implemented in a variety of ways depending on a chip structure. For example, in a case in which the ohmic-contact layer 1180 has a flip-chip structure, the ohmic-contact layer 1180 may include a metal such as Ag, Au, Al, and the like, and a transparent conductive oxide such as ITO (Indium Tin Oxide), ZIO (Zinc Indium Oxide), GIO (Gallium Indium Oxide), and the like. In a case in which the ohmic-contact layer 1180 does not have the flip-chip structure, the ohmic-contact layer 1180 may be configured with a light-transmitting electrode. The light-transmitting electrode may be provided as one of a transparent conductive oxide layer or a transparent conductive nitride layer. For example, the light-transmitting electrode may be at least one of indium tin oxide (ITO), zinc-doped indium tin oxide (ZITO), zinc indium oxide (ZIO), gallium indium oxide (GIO), zinc tin oxide (ZTO), fluorine-doped tin oxide (FTC)), aluminum-doped zinc oxide (AZO), gallium-doped zinc oxide (GZO), In4Sn3O12, or zinc magnesium oxide (Zn(1−x)MgxO, 0≦x≦1). If necessary, the ohmic contact layer 1180 may include graphene. The second electrode 1190b may contain at least one of Al, Au, Cr, Ni, Ti, or Sn.

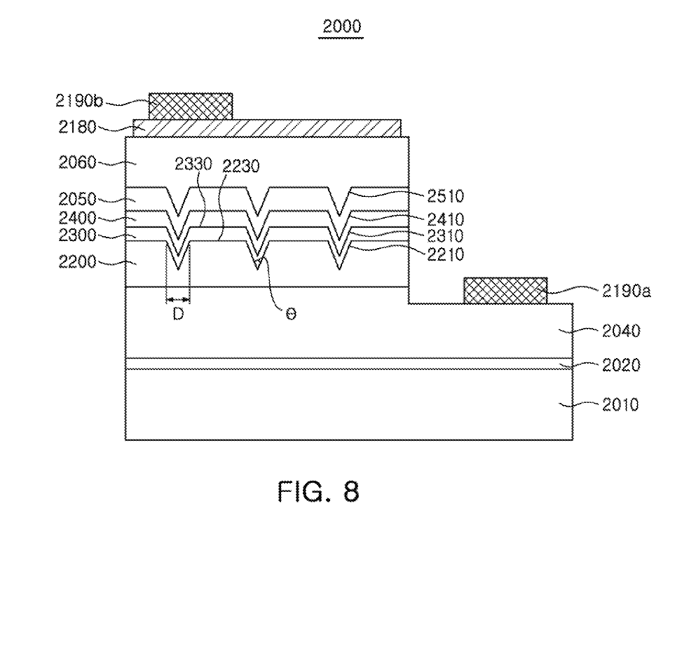

Referring to FIG. 8, a semiconductor light emitting device 2000 may include a substrate 2010, a first conductivity-type semiconductor layer 2040, an active layer 2050, and a second conductivity-type semiconductor layer 2060 sequentially disposed on the substrate 2010. A buffer layer 2020 may be disposed between the substrate 2010 and the first conductivity-type semiconductor layer 2040.

The substrate 2010 may be an insulation substrate such as a sapphire substrate, but is not limited thereto, and may be a conductive substrate or a semiconductor substrate. For example, the substrate may be a SiC, Si, MgAl₂O₄, MgO, LiAlO₂, LiGaO₂, or GaN substrate as well as a sapphire substrate.

The buffer layer 2020 may be an InₓAl_{y}Ga_{1-x-y}N (0≦x≦1, 0≦y≦1) layer. For example, the buffer layer 2020 may be a GaN, AlN, AlGaN, or InGaN layer. A thickness of the buffer layer 2020 may range from 0.1 nm to 500 nm. If necessary, a material such as ZrB₂, HfB₂, ZrN, HfN, TiN, and the like may be used. In further detail, the buffer layer 2020 may be provided as a layer in which a plurality of layers are combined or of which a composition is gradually changed.

The first conductivity-type semiconductor layer 2040 and the second conductivity-type semiconductor layer 2060 may have a single-layer structure, but if necessary, may have a multi-layer structure in which layers have different compositions or different thicknesses from each other. For example, at least one of the first conductivity-type semiconductor layer 2040 and the second conductivity-type semiconductor layer 2060 may have a carrier injection layer that is able to improve injection efficiency of electrons and/or holes, and may also have a variety of forms of superlattice structures.

The semiconductor light emitting device 2000 according to at least one example embodiment of the present inventive concepts may further include a V-pit generation layer 2200 on the first conductivity-type semiconductor layer 2040. The V-pit generation layer 2200 may be adjacent to the first conductivity-type semiconductor layer 2400. The V-pit generation layer 2200 may have a V-pit density of, for example, about 1×10⁸ cm⁻² to about 5×10⁸ cm⁻². According to at least one example embodiment of the present inventive concepts, the V-pit generation layer 2200 may have a thickness ranging from 200 nm to 800 nm. An entrance width of a V-pit 2210 may range from 200 nm to 800 nm.

The V-pit 2210 formed in the V-pit generation layer 2200 may have a vertical angle θ between about 10 to about 90 degrees, and for example, a vertical angle θ of between 20 to 80 degrees. In detail, when it is assumed that the V-pit 2210 is to be viewed as a cross section on a vertical plane passing through an apex thereof, an angle formed by two inclined planes of the V-pit 2210, meeting at the apex, may range between about 10 to 90 degrees.

The V-pit generated in at least one example embodiment of the present inventive concepts may have a growth surface (0001 surface) parallel to a surface of the substrate and an inclined growth surface (1-101 surface, 11-22 surface, or other inclined crystal surfaces) inclined with respect to the surface of the substrate, which are present together. The V-pit 2210 may be formed around a penetrating potential penetrating the light emitting structure, such that currents may be prevented from concentrating in the penetrating potential.

According to at least one example embodiment of the present inventive concepts, the V-pit generation layer 2200 may be a GaN layer or a GaN layer doped with an impurity.

A position in which the V-pit 2210 is generated in the V-pit generation layer 2200 may be adjusted by a growth temperature thereof. In a case in which the growth temperature thereof is relatively low, the V-pit 2210 may start being generated from a relatively lower position. On the other hand, in a case in which the growth temperature thereof is relatively high, the V-pit 2210 may start being generated from a relatively higher position.

For example, in the case of the V-pit generation layers having the same height, an entrance width of a V-pit generated from a relatively lower position of a V-pit generation layer may be greater than an entrance width of the other V-pit generated from a relatively higher position.

A membrane-improving layer 2300 may be provided on the V-pit generation layer 2200. The membrane-improving layer 2300 may have a composition of MₓGa₁₋ₓN. In the composition of MₓGa₁₋ₓN, M may be Al or In, and x may satisfy 0.01≦x≦0.3. According to at least one example embodiment of the present inventive concepts, x may also satisfy 0.02≦x≦0.08. In a case in which an x value of the composition of MₓGa₁₋ₓN is relatively too small, the effect of membrane improvement may not be satisfied. In contrast, in a case in which the x value in the composition of MₓGa₁₋ₓN is relatively too high, a light emitting characteristic may be degraded. The x value thereof may be constant in the membrane-improving layer 2300. Selectively, the membrane-improving layer 2300 may have a multi-layer structure in which a GaN layer and a MₓGa₁₋ₓN layer (here, M is Al or In, and x satisfies 0.01≦x≦0.3) are alternately stacked. Selectively, the membrane-improving layer 2300 may be a superlattice layer of GaN and MₓGa₁₋ₓN (here, M is Al or In, and x satisfies 0.01≦x≦0.3). A thickness of the membrane-improving layer 2300 may range from about 20 nm to about 100 nm.

The membrane-improving layer 2300 may be formed entirely on an upper surface of the V-pit generation layer 2200. In addition, the membrane-improving layer 2300 may have approximately a constant thickness in a direction perpendicular to the upper surface of the V-pit generation layer 2200.

The membrane-improving layer 2300 may at least partially fill the V-pit 2210 of the V-pit generation layer 2200, by covering an inside of the V-pit 2210 at a desired (and/or alternatively predetermined) thickness. A V-pit 2310 of the membrane-improving layer 2300 may be recessed into the V-pit 2210 of the V-pit generation layer 2200. The thickness of the membrane-improving layer 2300 in a direction perpendicular to the upper surface of the V-pit generation layer 2200 may be about 5% to about 20% of a thickness of the V-pit generation layer 2200.

The V-pit 2310 formed in the membrane-improving layer 2300 may have approximately the same dimension as or a dimension similar to a dimension of the V-pit 2210 of the V-pit generation layer 2200.

In addition, an upper surface 2330 of the membrane-improving layer 2300 may have an improved surface roughness as compared with an upper surface 2230 of the V-pit generation layer 2200. For example, a surface roughness of the upper surface 2330 of the membrane-improving layer 2300 may be 60% or lower of a surface roughness of the upper surface 2230 of the V-pit generation layer 2200. Such a surface roughness may be measured by an atomic force microscope (AFM). The surface roughness may refer to a surface roughness measured with respect to an upper surface, except for the V-pits 2210 and 2310. In addition, the surface roughness may be determined by measuring uniformity (or flatness) of an interface. For example, uniformity of an interface between the membrane-improving layer 2300 and a surface adjacent thereto may be excellent as compared to that of an interface between the V-pit generation layer 2200 and a surface adjacent thereto.

As described above, as the surface roughness of the upper surface 2330 of the membrane-improving layer 2300 is improved, the surface roughness of a quantum barrier layer and a quantum well layer in the active layer 2050 disposed on the membrane-improving layer 2300 may also be improved. As a result, a non-luminous electron-hole-recombination may be decreased, such that the light emitting characteristic may be significantly improved.

The light emitting device 2000 may further include a superlattice layer 2400 above the first conductivity-type semiconductor layer 2040, adjacent to the active layer 2050. The superlattice layer 2400 may have a structure in which a plurality of InₓAl_{y}Ga_{(1-x-y)}N (0≦x<1, 0≦y<1, 0≦x+y<1) layers having different compositions or different impurity contents from each other are repeatedly stacked, or an insulating material layer is partially formed therein. The superlattice layer 2400 may promote diffusion of current, such that light may be uniformly emitted in a relatively large area.

A V-pit 2410 corresponding to the V-pit 2310 formed in the membrane-improving layer 2300 may be formed in the superlattice layer 2400.

The superlattice layer 2400 may at least partially fill the V-pit 2310 of the membrane-improving layer 2300 by covering an inside of the V-pit 2310 at a desired (and/or alternatively predetermined) thickness. The V-pit 2410 of the superlattice layer 2400 may be recessed into the V-pit 2310 of the membrane-improving layer 2300.

The second conductivity-type semiconductor layer 2060 may further include an electron-blocking layer disposed adjacent to the active layer 2050. The electron-blocking layer (EBL) may have a structure in which a plurality of InₓAl_{y}Ga_{(1-x-y)}N layers having different compositions are stacked, or have one or more Al_{y}Ga_{(1-y)}N layers. Since the electron-blocking layer has a band gap greater than a band gap of the active layer 2050, electrons may be prevented from moving to the second conductivity-type (P-type) semiconductor layer 2060.

A valley of a V-shape of the V-pit 2210 formed in the V-pit generation layer 2200 may become relatively gentler as the valley is closer to the second conductivity-type semiconductor layer 2060 in a thickness direction of respective layers, and may be flattened by the superlattice layer 2400 or the second conductivity-type semiconductor layer 2060.

The semiconductor light emitting device 2000 may include a first electrode 2190a disposed on the first conductivity-type semiconductor layer 2040, and an ohmic contact layer 2180 and a second electrode 2190b sequentially disposed on the second conductivity-type semiconductor layer 2060.

The first electrode 2190a may include a material such as Ag, Ni, Al, Cr, Rh, Pd, Ir, Ru, Mg, Zn, Pt, Au, and the like, but is not limited thereto. The first electrode 2190a may have a single-layer structure or a multi-layer structure. A pad electrode layer may be further provided on the first electrode 2190a. The pad electrode layer may be a layer containing at least one of Au, Ni, and Sn.

The ohmic-contact layer 2180 may be implemented in a variety of ways depending on a chip structure. For example, in a case in which the ohmic-contact layer 2180 has a flip-chip structure, the ohmic-contact layer 2180 may include a metal such as Ag, Au, Al, and the like, and a transparent conductive oxide such as Indium Tin Oxide (ITO), Zinc Indium Oxide (ZIO), Gallium Indium Oxide (GIO), and the like. In a case in which the ohmic-contact layer 2180 has a structure opposing the flip-chip structure, the ohmic-contact layer 2180 may be configured of a light-transmitting electrode. The light-transmitting electrode may be provided as one of a transparent conductive oxide layer or a transparent conductive nitride layer. For example, the light-transmitting electrode may be at least one of indium tin oxide (ITO), zinc-doped indium tin oxide (ZITO), zinc indium oxide (ZIO), gallium indium oxide (GIO), zinc tin oxide (ZTO), fluorine-doped tin oxide (FTC)), aluminum-doped zinc oxide (AZO), gallium-doped zinc oxide (GZO), In4Sn3O12, or zinc magnesium oxide (Zn(1−x)MgxO, 0≦x≦1). If necessary, the ohmic contact layer 2180 may include graphene. The second electrode 2190b may contain at least one of Al, Au, Cr, Ni, Ti, and Sn.

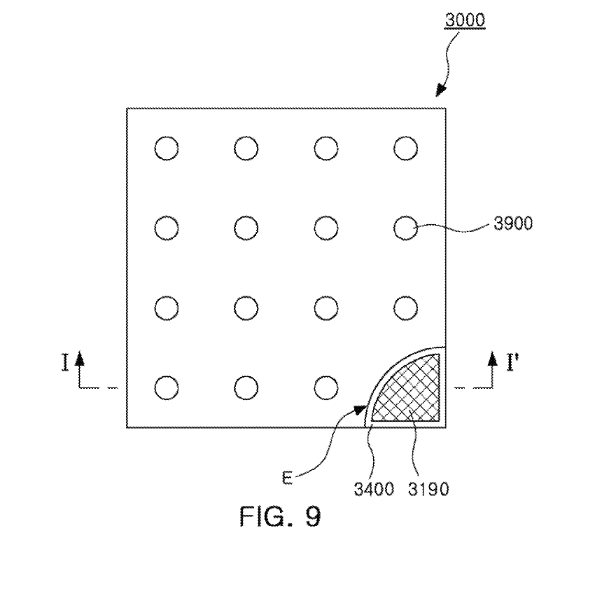

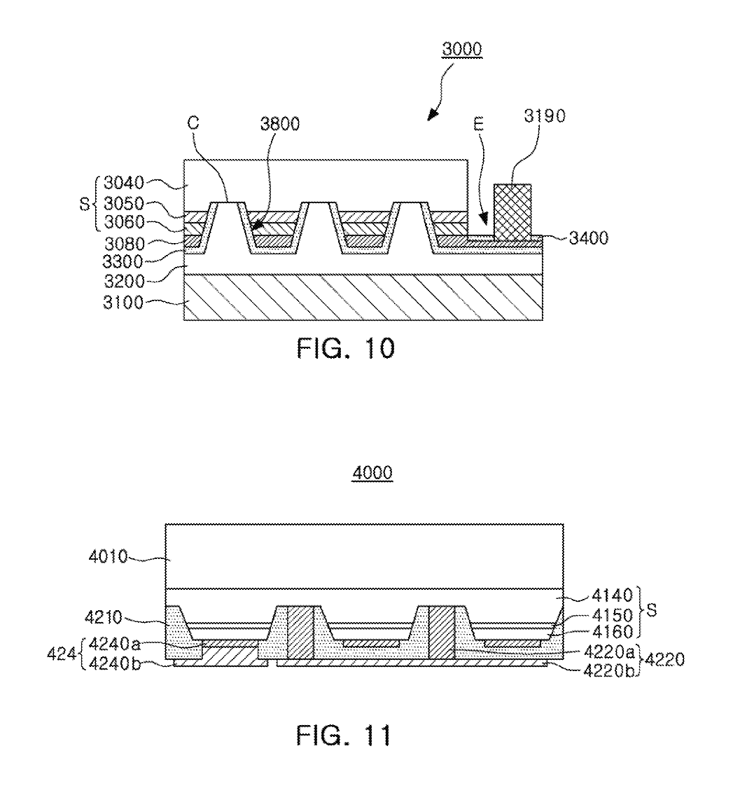

FIG. 9 is a plan view illustrating a semiconductor light emitting device which may be validated by a design validation system according to at least one example embodiment of the present inventive concepts, and FIG. 10 is a side cross-sectional view of the semiconductor light emitting device taken along line I-I′ of FIG. 9.

A semiconductor light emitting device 3000 illustrated in FIGS. 9 and 10 may be provided for lighting and have a large-area structure for high light emission efficiency. The semiconductor light emitting device 3000 may have a structure for efficient diffusion of current and efficient heat radiation.

The semiconductor light emitting device 3000 may include a light-emitting laminate S, a first electrode 3200, an insulation layer 3300, a second electrode 3080, and a substrate 3100. The light emitting laminate S may include a first conductivity-type semiconductor layer 3040, an active layer 3050, and a second conductivity-type semiconductor layer 3060.

The first electrode 3200 may include one or more conductive vias 3800 extended to at least a portion of the first conductivity-type semiconductor layer 3040 so as to be electrically connected to the first conductivity-type semiconductor layer 3040, while being electrically insulated from the second conductivity-type semiconductor layer 3060 and the active layer 3050. The conductive via 3800 may be extended from an interface of the first electrode 3200 into the first conductivity-type semiconductor layer 3040 to penetrate through the second electrode 3080, the second conductivity-type semiconductor layer 3060, and the active layer 3050. The conductive via 3800 may be formed using an etching process such as ICP-RIE and the like.

The insulation layer 3300 may be provided on the first electrode 3200 such that the first electrode 3200 may be electrically insulated from areas other than the conductive substrate 3100 and the first conductivity-type semiconductor layer 3040. As illustrated in FIG. 10, the insulation layer 3300 may be formed on a side surface of the conductive via 3800 as well as a contact region between the second electrode 3080 and the first electrode 3200, such that the first electrode 3200 may be insulated from the second electrode 3080, the second conductivity-type semiconductor layer 3060, and the active layer 3050 exposed to the side surface of the conductive via. The insulation layer 3300 may be formed by depositing an insulating material such as SiO₂, SiOₓN_{y}, SiₓN_{y}, and the like.

A contact region C of the first conductivity-type semiconductor layer 3040 may be exposed by the conductive via 3800, and the first electrode 3200 may be formed so that a portion thereof comes into contact with the contact region C through the conductive via 3800. Thus, the first electrode 3200 may be connected to the first conductivity-type semiconductor layer 3040.

The number, a shape, and a pitch of the conductive via 3800, a contact diameter (or contact area) thereof with the first and second conductivity-type semiconductor layers 3040 and 3060 may be appropriately adjusted so that contact resistance of the conductive via 3800 may be decreased (see FIG. 9), and the conductive vias 3800 may be arrayed in rows and columns in a variety of forms so as to improve a flow of electric current.

The number of the conductive vias 3800 and the contact area thereof may be adjusted so that an area of the contact region C may be between about 0.1% and 20% of a planar area of the light emitting laminate S. For example, the area of the contact region C may be in a range of 0.5% to 15% of the planar area of the light emitting laminate S, and in further detail, 1% to 10% thereof. In a case in which the area of the contact region C is less than 0.1% of the planar area of the light emitting laminate S, diffusion of currents may not be uniform, and thus, a light emitting characteristic may be degraded. In a case in which the area of the contact region C is equal to or greater than 20% of the planar area of the light emitting laminate S, the light emitting area may be relatively reduced, and thus, the light emitting characteristic may be degraded and the level of brightness may be decreased.

A radius of the conductive via 3800 in a region coming in contact with the first conductivity-type semiconductor layer 3040 may range, for example, from 1 μm to 50 μm, and the number of the conductive vias 3800 may be one to 48,000 per region of the light-emitting laminate S, depending on an area of the light-emitting laminate S. The number of the conductive vias 3800 may be changed depending on the area of the light-emitting laminate S, and for example, may be two to 45,000, in detail, 5 to 40,000, in further detail, 10 to 35,000. The conductive vias 3800 may be provided in a matrix structure having rows and columns, in which a distance between the conductive vias 3800 may range from 10 μm to 1,000 μm, in detail, from 50 μm to 700 μm, in more detail, from 100 μm to 500 μm, and in further detail, from 150 μm to 400 μm.

In a case in which the distance between the conductive vias 3800 is less than 10 μm, the number of conductive vias may increase, and as the light emitting area relatively decreases, light emitting efficiency may be reduced. In a case in which the distance between the conductive vias 3800 is greater than 1000 μm, current may not be diffused appropriately, and thus, light emitting efficiency may be reduced. A depth of the conductive via 3800 may be determined by thicknesses of the second conductivity-type semiconductor layer 3060 and the active layer 3050, and may be between, for example, 0.1 μm and 5.0 μm.

As illustrated in FIG. 10, the second electrode 3080 may be extended outside of the light emitting laminate S to provide an exposed electrode-forming region E. The electrode-forming region E may have an electrode pad unit 3190 formed thereon to connect external power to the second electrode 3080. The electrode-forming region E has been illustrated as being singular, but if necessary, a plurality of electrode-forming regions may be employed. As illustrated in FIG. 9, in order to significantly increase the light emitting area, the electrode-forming region E may be formed in a corner of the nitride semiconductor light emitting device 3000.

According to at least one example embodiment of the present inventive concepts, an insulation layer for an etch stop 3400 may be disposed around the electrode pad unit 3190. The insulation layer for an etch stop 3400 may be formed in the electrode-forming region E after the light emitting laminate S is formed and before the second electrode 3080 is formed. The insulation layer for an etch stop 3400 may serve as an etch stop at the time of performing an etching process for the electrode-forming region E.

The second electrode 3080 may be formed of a material having ohmic contact with the second conductivity-type semiconductor layer 3060 and having relatively high reflectivity. As the material forming the second electrode 3080, a repellent material described above may be used.

Referring to FIG. 11, a semiconductor light emitting device 4000 may include a semiconductor laminate S formed on a substrate 4010. The semiconductor laminate S may include a first conductivity-type semiconductor layer 4140, an active layer 4150, and a second conductivity-type semiconductor layer 4160.

The semiconductor light emitting device 4000 may include a first electrode 4220 and a second electrode 4240 respectively connected to the first conductivity-type semiconductor layer 4140 and the second conductivity-type semiconductor layer 4160. The first electrode 4220 may include a connection electrode unit 4220a, like a conductive via, penetrating through the second conductivity-type semiconductor layer 4160 and the active layer 4150 to be connected to the first conductivity-type semiconductor layer 4140, and a first electrode pad 4220b connected to the connection electrode unit 4220a. The connection electrode unit 4220a may be surrounded by an insulation unit 4210 to be insulated from the active layer 4150 and the second conductivity-type semiconductor layer 4160. The connection electrode unit 4220a may be disposed in a region in which the semiconductor laminate S is etched. The number, a shape, a pitch, a region coming in contact with the first conductivity-type semiconductor layer 4140, and the like of the connection electrode unit 4220a may be appropriately designed so that contact resistance of the connection electrode unit 4220a may be reduced. In addition, a flow of electric current may be improved by arraying the connection electrode units 4220a in rows and columns on the semiconductor laminate S. The second electrode 4240 may include an ohmic contact layer 4240a and a second electrode pad 4240b on the second conductivity-type semiconductor layer 4160.

The connection electrode unit 4220a and the ohmic contact layer 4240a may include a single-layer or multi-layer structure of a conductive material, such that they have an ohmic contact with the first conductivity-type semiconductor layer 4140 and the second conductivity-type semiconductor layer 4160, respectively. For example, the connection electrode unit 4220a and the ohmic contact layer 4240a may be formed by depositing or sputtering one or more of materials such as Ag, Al, Ni, Cr, transparent conductive oxide (TCO), and the like.

The first electrode pad 4220b and the second electrode pad 4240b may be respectively connected to the connection electrode unit 4220a and the ohmic contact layer 4240a to serve as external terminals of the semiconductor light emitting device 4000. For example, the first electrode pad 4220b and the second electrode pad 4240b may be formed using Au, Ag, Al, Ti, W, Cu, Sn, Ni, Pt, Cr, NiSn, TiW, AuSn, or a eutectic metal thereof.

The first electrode 4220 and the second electrode 4240 may be disposed in a single direction, and may be mounted on a lead frame or the like in a so-called flip-chip structure.

The first electrode 4220 and the second electrode 4240 may be electrically insulated from each other by the insulation unit 4210. As the insulation unit 4210, any material that has an electrical insulation characteristic may be used, and any object that has an insulation characteristic may be used, but a material having a relatively low optical absorption rate may be used. As the insulation unit 4210, for example, a silicon oxide or silicon nitride such as SiO₂, SiOₓN_{y}, SiₓN_{y}, and the like may be used. If necessary, a light reflection structure may be formed by diffusing light reflective filler into a light-transmitting material. The insulation unit 4210 may have a multi-layer reflective structure in which a plurality of insulation films having different refractive indices from each other are alternately stacked. For example, the multi-layer reflection structure may be a distributed Bragg reflector (DBR) structure in which a first insulation film having a first refractive index and a second insulation film having a second refraction index are alternately stacked.

The multi-layer reflection structure may have a structure in which a plurality of insulation films having different refractive indices are alternately stacked two to 100 times. For example, the plurality of insulation films may be repeatedly stacked 3 to 70 times, in detail, 4 to 50 times. Each of the plurality of insulation films of the multi-layer reflection structure may be formed using oxide or nitride such as SiO₂, SiN, SiOₓN_{y}, TiO₂, Si₃N₄, Al₂O₃, TiN, AlN, ZrO₂, TiAlN, TiSiN, and the like, and a combination thereof. For example, when a wavelength of light generated in the active layer is λ, and a refractive index of a corresponding layer is n, the first insulation film and the second insulation film may be formed to have a thickness of λ/4n, in detail, a thickness of about 300 Å to 900 Å. The first insulation film and the second insulation film may be designed to selectively have a thickness and a refractive index so as to have a relatively high degree of reflectivity (95% or more) with respect to the wavelength of light generated in the active layer 4150.

Refractive indices of the first insulation film and the second insulation film may be determined to be between about 1.4 and about 2.5. The refractive indices of the first insulation film and the second insulation film may be less than a refractive index of the first conductivity-type semiconductor layer 4040 or a refractive index of the substrate 4010, but may also be less than the refractive index of the first conductivity-type semiconductor layer 4040 and greater than the refractive index of the substrate 4010.

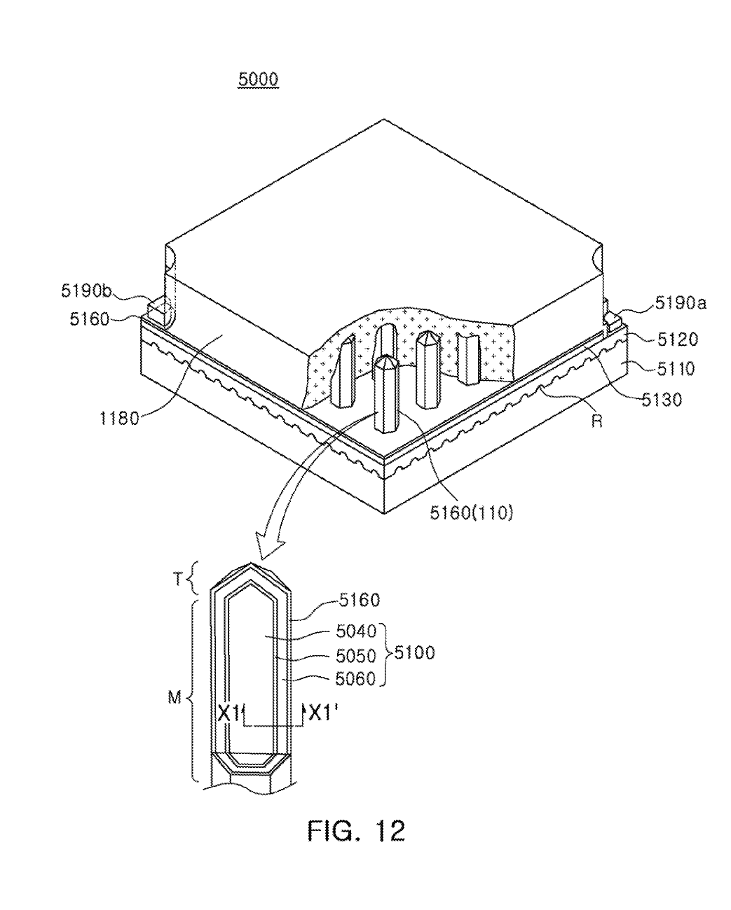

FIG. 12 is an example of a semiconductor light emitting device which may be employed according to at least one example embodiment of the present inventive concepts.

Referring to FIG. 12, a semiconductor light emitting device 5000 may include a base layer 5120 formed of a first conductivity-type semiconductor material, and a plurality of nano-light emitting structures 5100 disposed on the base layer 5120.

The semiconductor light emitting device 5000 may include a substrate 5110 having an upper surface on which the base layer 5120 is disposed. The upper surface of the substrate 5110 may have an uneven portion R thereon. The uneven portion R may improve light extraction efficiency and quality of a single crystal grown. The substrate 5110 may be an insulation substrate, a conductive substrate, or a semiconductor substrate. For example, the substrate 5110 may be a sapphire, SiC, Si, MgAl₂O₄, MgO, LiAlO₂, LiGaO₂, or GaN substrate.

The base layer 5120 may include a first conductivity-type nitride semiconductor layer and provide a growth surface for the nano-light emitting structures 5100. The base layer 5120 may be a nitride semiconductor satisfying InₓAl_{y}Ga_{1-x-y}N (0≦x<1, 0≦y<1, 0≦x+y<1), and be doped with an N-type impurity such as Si. For example, the base layer 5120 may be an N-type GaN layer.

An insulation film 5130 having an opening for a growth of the nano-light emitting structure 5100 (in detail, a nano core 5040) may be formed on the base layer 5120. The nano core 5040 may be formed in a portion of the base layer 5120 exposed to the opening. The insulation film 5130 may be used as a mask for growth of the nano core 5040. For example, the insulation film 5130 may be formed of an insulating material such as SiO₂ or SiNₓ.

The nano-light emitting structure 5100 may include a main portion M having a hexagonal prism structure, and a top portion T on the main portion M. The main portion M of the nano-light emitting structure 5100 may have side surfaces, identical crystal surfaces, and the top portion T of the nano-light emitting structure 5100 may have a crystal surface different from the crystal side surfaces of the nano-light emitting structure 5100. The top portion T of the nano-light emitting structure 5100 may have a hexagonal-pyramidal shape. Such a structure may be determined by the nano core 5040, and the nano core 5040 may be understood as being divided into the main portion M and the top portion T.

The nano-light emitting structure 5100 may include the nano core 5040 configured of a first conductivity-type nitride semiconductor, and an active layer 5050 and a second conductivity-type nitride semiconductor layer 5060 sequentially disposed on a surface of the nano core 5040.

The semiconductor light emitting device 5000 may include a contact electrode 5160 connected to the second conductivity-type nitride semiconductor layer 5060. According to at least one example embodiment of the present inventive concepts, the contact electrode 5160 may be formed of a light-transmitting conductive material. The contact electrode 5160 may guarantee light emission towards the nano-light emitting structure (in a direction opposite a direction toward the substrate). The contact electrode 5160 may be a transparent conductive oxide layer or a transparent conductive nitride layer, but is not limited thereto. For example, the contact electrode 5160 may be at least one selected from indium tin oxide (ITO), zinc-doped indium tin oxide (ZITO), zinc indium oxide (ZIO), gallium indium oxide (GIO), zinc tin oxide (ZTO), fluorine-doped tin oxide (FTC)), aluminum-doped zinc oxide (AZO), gallium-doped zinc oxide (GZO), In4Sn3O12, or zinc magnesium oxide (Zn(1−x)MgxO, 0≦x≦1). If necessary, the contact electrode 5160 may include graphene.

A material forming the contact electrode 5160 may not be limited to a transparent material, but if necessary, the contact electrode 5160 may have a reflective electrode structure. For example, the contact electrode 5160 may include a material such as Ag, Ni, Al, Rh, Pd, Ir, Ru, Mg, Zn, Pt, Au, and the like, and may be adopted as two or more layer structure such as Ni/Ag, Zn/Ag, Ni/Al, Zn/Al, Pd/Ag, Pd/Al, Ir/Ag, Ir/Au, Pt/Ag, Pt/Al, Ni/Ag/Pt, and the like. The contact electrode 5160 may be implemented in a flip-chip structure by employing such a reflective electrode structure.

An insulating protective layer 5180 may be formed on the nano-light emitting structure 5100. The insulating protective layer 5180 may be a passivation for a protection of the nano-light emitting structure 5100. The insulating protective layer 5180 may be formed of a light transmitting material so that light generated in the nano-light emitting structures 5100 can be extracted therefrom. In this case, light extraction efficiency may be improved by selecting a material having an appropriate refractive index as a material of the insulating protective layer 5180.

After the contact electrode 5160 is formed as described in at least one example embodiment of the present inventive concepts, the insulating protective layer 5180 may fill a space between a plurality of nano-light emitting structures. For the insulating protective layer 5180, an insulating material such as SiO₂ and SiNx may be used. For example, tetraethyl orthosilane (TEOS), borophospho silicate glass (BPSG), CVD-SiO₂, spin-on glass (SOG), and spin-on dielectric (SOD) material may be used as the insulating protective layer 5180.

The insulating protective layer 5180 has been employed in order to fill in the space between the nano-light emitting structures 5100 in at least one example embodiment of the present inventive concepts, but is not limited thereto. For example, in another example embodiment of the present inventive concepts, the space between the nano-light emitting structures 5100 may be filled with an electrode element (e.g. reflective electrode material) such as the contact electrode 5160.

The semiconductor light emitting device 5000 may include a first electrode 5190a and a second electrode 5190b. The first electrode 5190a may be disposed in a region to which a portion of the base layer 5120 formed of a first conductive semiconductor is exposed. The second electrode 5190b may be disposed in a region to which the contact electrode 5160 is extended to be exposed. An array of the electrodes is not limited thereto, and the electrodes may be arrayed in a variety of ways depending on the service environment.

In the semiconductor light emitting device 5000 having a core/shell nano structure, the amount of heat generated therein is relatively low due to relatively low joint density thereof, and light emitting efficiency thereof may be increased by increasing the light emitting area using the nano structure. In addition, an efficiency drop occurring due to polarization may be prevented thanks to a non-polar active layer thereof, and thus, a droop characteristic thereof may be reduced.

A plurality of openings in the mask layer may have different diameters or different intervals (pitches) between each other, amounts of indium mixed included in active layers of the plurality of nano-light emitting structures may be different, or doping concentrations thereof may be different, such that the plurality of nano-light emitting structures 5100 may emit light having two or more different wavelengths. White light may be implemented without using a fluorescent substance in a single device by appropriately adjusting light having different wavelengths, and light having a variety of colors or white light having different color temperatures may be implemented by combining the aforementioned device with an LED chip or a wavelength conversion material such as a fluorescent substance.

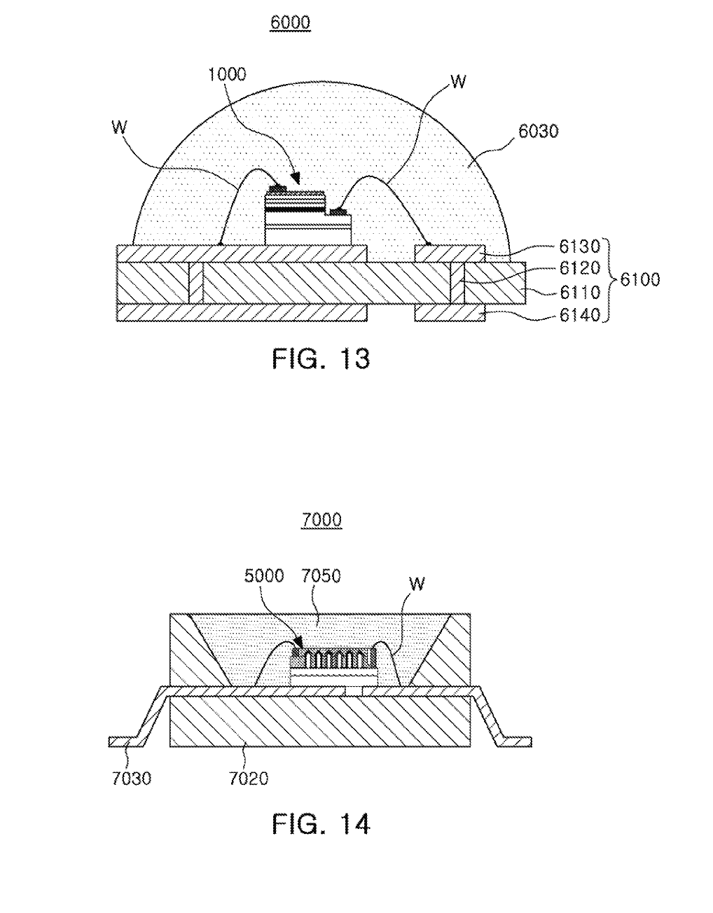

FIGS. 13 to 15 are views illustrating a semiconductor light emitting device package which can be virtually validated by a design validation system according to at least one example embodiment of the present inventive concepts.

A semiconductor light emitting device package 6000 illustrated in FIG. 13 may include the semiconductor light emitting device 1000 of FIG. 7, a mounting substrate 6100, and an encapsulating portion 6030. The semiconductor light emitting device 1000 may be mounted on the mounting substrate 6100 to be electrically connected to the mounting substrate 6100 through a wire W. The mounting substrate 6100 may include a main body 6110, an upper electrode 6130, a lower electrode 6140, and a penetrating electrode 6120 connecting the upper electrode 6130 and the lower electrode 6140 to each other. The main body 6110 of the mounting substrate 6100 may be a resin, ceramic, or metal substrate, and the upper electrode 6130 or the lower electrode 6140 may be of a metal layer formed using Au, Cu, Ag, or Al. For example, the mounting substrate 6100 may be provided as a printed circuit board (PCB), a metal core printed circuit board (MCPCB), a metal printed circuit board (MPCB), a flexible printed circuit board (FPCB), and the like, and a structure thereof may be applied in a variety of ways.

The encapsulating portion 6030 may be formed as a dome-shaped lens structure having a convex upper surface, but depending on various example embodiments of the present inventive concepts, a beam spread angle of light emitted through the upper surface of the encapsulating unit 6030 may be adjusted by forming the structure of the lens to be convex or concave.

Referring to FIG. 14, a semiconductor light emitting device package 7000 may include a nano structure semiconductor light emitting device 5000 of FIG. 12, a package body 7020, and a pair of lead frames 7030.

The nano structure semiconductor light emitting device 5000 may be mounted on the lead frames 7030 so that a respective electrode thereof can be electrically connected to the lead frames 7030 through a wire W. If necessary, the nano structure semiconductor light emitting device 5000 may be mounted in a region not a region of the lead frames 7030, for example, in the package main body 7020. The package main body 7020 may include a cup-shaped recess portion so that reflection efficiency of light can be increased, and in the recess portion, an encapsulating portion 7050 formed of a light transmitting material may be formed to encapsulate the nano structure semiconductor light emitting device 5000, the wire W, and the like. If necessary, a wavelength conversion material such as a fluorescent substance and/or a quantum dot may be contained in the encapsulating portion 7050.

As another example of a semiconductor light emitting device package, an LED chip package having a chip scale package (CSP) structure may be used. The chip scale package may be appropriate for mass production in that a size of an LED chip package may be reduced and a manufacturing process may be simplified. In addition, the chip scale package may be appropriate for lightings in that the LED chip may be integrally manufactured with a wavelength conversion material such as a fluorescent substance and an optical structure such as a lens.

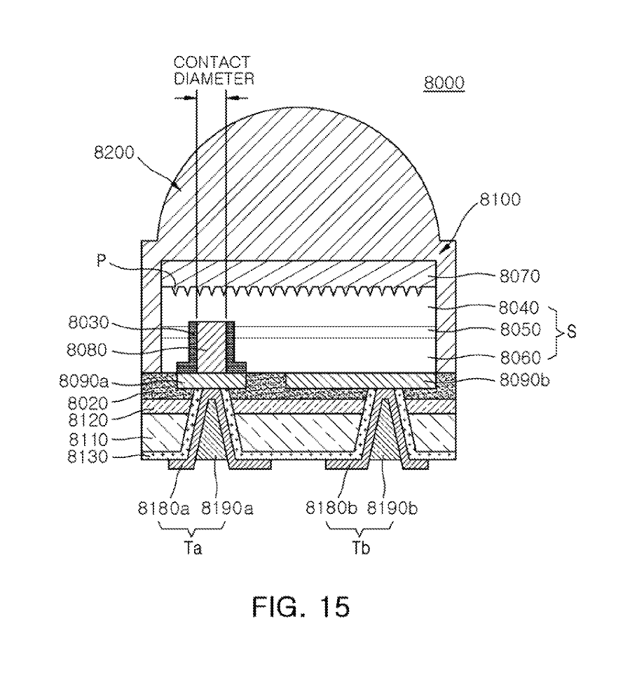

FIG. 15 is a plan view illustrating an example of a chip scale semiconductor light emitting device package which can be adopted according to at least one example embodiment of the present inventive concepts.

Referring to FIG. 15, a light emitting device package 8000 may include a light emitting laminate S disposed on a substrate 8110, a first terminal Ta, a second terminal Tb, a fluorescent substance layer 8070, and a lens 8200. An electrode may be formed on a lower surface of a light emitting device 8100, opposing a main light extraction surface of the light emitting device package 8000. The fluorescent substance layer 8070 and the lens 8200 may be integrally formed in the light emitting device package 8000.

The light emitting laminate S has a structure in which a first conductivity-type semiconductor layer 8040, an active layer 8050, and a second conductivity-type semiconductor layer 8060 are laminated. According to at least one example embodiment of the present inventive concepts, the first conductivity-type semiconductor layer 8040 and the second conductivity-type semiconductor layer 8060 may be a P-type semiconductor layer and an N-type semiconductor layer, respectively, and may be configured of a nitride semiconductor satisfying AlₓIn_{y}Ga_{(1-x-y)}N (0<x<1, 0<y<1, 0<x+y<1), but is not limited thereto. A GaAs-based semiconductor or a GaP-based semiconductor may also be used.

The active layer 8050 formed between the first conductivity-type semiconductor layer 8040 and the second conductivity-type semiconductor layer 8060 may emit light having a desired or predetermined amount of energy due to recombination of electrons and holes, and have a multiple quantum well (MQW) structure in which a quantum well layer and a quantum barrier layer are alternately laminated. For the multiple quantum well structure, for example, an InGaN/GaN structure or a AlGaN/GaN structure may be used.

The semiconductor light emitting device 8100 is in a state in which a growth substrate has been removed therefrom, and an uneven portion P may be formed on the surface from which the growth substrate has been removed. In addition, as an optical conversion layer, the fluorescent substance layer 8070 may be applied to the surface on which the uneven portion P is formed. The growth substrate may not be removed from the semiconductor light emitting device 8100, and the uneven portion P and the optical conversion layer may be formed on a back side of the growth substrate. The semiconductor light emitting device 8100 may have a first electrode 8090a connected to the first conductivity-type semiconductor layer 8040, and a second electrode 8090b connected to the second conductivity-type semiconductor layer 8060. The first electrode 8090a may have a conductive via 8080 penetrating through the second conductivity-type semiconductor layer 8060 and the active layer 8050 to be connected to the second conductivity-type semiconductor layer 8060. An insulation layer 8030 may be formed between the conductive via 8080 and the active layer 8050 and between the conductive via 8080 and the second conductivity-type semiconductor layer 8060, such that short circuits may be prevented from occurring.

In FIG. 15, the first electrode 8090a has been illustrated as having a single conductive via 808, but two or more conductive vias may be included in the first electrode 8090a to facilitate diffusion of electrons, and the two or more conductive vias may be arrayed in a variety of ways. The conductive vias 8080 may be arrayed in a similar way to a conductive via in FIG. 9 or FIG. 10.

The mounting substrate 8110 employed in at least one example embodiment of the present inventive concepts has been illustrated as a supporting substrate such as a silicon substrate to which a semiconductor process may be easily applied, but is not limited thereto. The mounting substrate 8110 and the light emitting device 8100 may be joined by bonding layers 8020 and 8120. The bonding layers 8020 and 8120 may be formed of an electrical insulating material or an electrical conductive material. For example, the electrical insulating material may be an oxide such as SiO₂, SiN, and the like, or a resin such as silicon resin or epoxy resin, and the electrical conductive material may be Ag, Al, Ti, W, Cu, Sn, Ni, Pt, Cr, NiSn, TiW, AuSn, or an eutectic metal thereof. This process may be implemented by applying a first bonding layer 8020 and a second bonding layer 8120 to respective facing surfaces of the semiconductor light emitting device 8100 and the mounting substrate 8110 and then joining the semiconductor light emitting device 8100 and the mounting substrate 8110. According to various example embodiments of the present inventive concepts, the first electrode 8090a and the second electrode 8090b may be connected to a first terminal Ta and a second terminal Tb of the mounting substrate 8110, without the bonding layers 8020 and 8120.

As set forth above, according to various example embodiments of the present inventive concepts, at least one of a plurality of a product characteristics calculated from design data input by a user may be virtually validated through a simulation process. For example, a plurality of design validation devices may perform simulation processes to validate one or more product characteristics in parallel, such that the efficiency of the simulation processes may be improved. In addition, the design data may be provided as STEP data of the International Organization for Standardization (ISO) when the simulation processes are performed, such that a universal design validation system, which is not affected by various computer environments of users, may be provided.

The units and/or modules described herein may be implemented using hardware components, software components, or a combination thereof. For example, the hardware components may include microcontrollers, memory modules, sensors, amplifiers, band-pass filters, analog to digital converters, and processing devices, or the like. A processing device may be implemented using one or more hardware device configured to carry out and/or execute program code by performing arithmetical, logical, and input/output operations. The processing device (s) may include a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such as parallel processors, multi-core processors, distributed processing, or the like.

The software may include a computer program, apiece of code, an instruction, or some combination thereof, to independently or collectively instruct and/or configure the processing device to operate as desired, thereby transforming the processing device into a special purpose processor. Software and data may be embodied permanently or temporarily in any type of machine, component, physical or virtual equipment, or computer storage medium or device. The software also may be distributed over network coupled computer systems so that the software is stored and executed in a distributed fashion. The software and data may be stored by one or more non-transitory computer readable recording mediums.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of some example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

It should be understood that example embodiments described herein should be considered in a descriptive sense only and not for purposes of limitation. Descriptions of features or aspects within each device or method according to example embodiments should typically be considered as available for other similar features or aspects in other devices or methods according to example embodiments. While some example embodiments have been particularly shown and described, it will be understood by one of ordinary skill in the art that variations in form and detail may be made therein without departing from the spirit and scope of the claims.

What is claimed is:

1. A design validation system, comprising:
a plurality of design validation devices each configured to receive design data and perform at least one simulation process to validate at least one of a plurality of product characteristics calculated from the design data;
a simulation management device configured to save simulation information associated with a performance of the simulation process according to the at least one of the plurality of product characteristics and transmit the simulation information to at least one of the plurality of design validation devices when receiving a request from the at least one of the plurality of design validation devices; and
the plurality of design validation devices are each configured to perform simulation processes to validate the at least one of the plurality of product characteristics.

2. The design validation system of claim 1, wherein the plurality of design validation devices are configured to simultaneously perform the simulation processes to validate desired product characteristics among the plurality of product characteristics.

3. The design validation system of claim 1, wherein
the simulation management device is configured to allocate the simulation processes to the plurality of design validation devices depending on a workload of each design validation device, and
the workload of each design validation device is determined based on the simulation processes currently being performed or standing by in the queue associated with each of the plurality of respective design validation devices.

4. The design validation system of claim 1, wherein the design data includes design data for at least one product of a light emitting device and a light emitting device package.

5. The design validation system of claim 4, wherein the design data includes at least one of structure data of the product, material property data contained in the product, and power data applied to the product.

6. The design validation system of claim 4, wherein the plurality of product characteristics include at least two of structural stress of the product, structural deformation of the product, heat radiation of the product, and light output of the product.

7. The design validation system of claim 1, wherein the design data includes Standard for the Exchange of Product Model (STEP) data.

8. The design validation system of claim 7, wherein the STEP data is provided as at least one of an AP203 file and an AP214 file.

9. The design validation system of claim 7, wherein the design validation devices are each configured to:
extract data required for a validation of the at least one of the plurality of product characteristics from the STEP data; and
validate the at least one of the plurality of product characteristics based on the extracted data and the simulation information.

10. The design validation system of claim 1, wherein the simulation information includes at least one of a software module, the software module including the simulation process, and input parameter information for the product characteristics to be validated by the simulation process.

11. The design validation system of claim 10, wherein the design validation device is configured to compile program source code included in the software module and perform the simulation process.

12. The design validation system of claim 1, wherein the plurality of design validation devices and the simulation management device are included in at least one server.

13. The design validation system of claim 1, wherein the design validation devices are each configured to manage the simulation information transmitted by the simulation management device by assigning unique identifiers (IDs) to the simulation information.

14. The design validation system of claim 13, wherein the design validation devices are each configured to manage result data calculated by performing the simulation process based on the simulation information transmitted by the simulation management device, according to the unique IDs.

15. A design validation system, comprising:
a computing device configured to receive a design drawing input through the computing device, and convert the design drawing into design data;
a plurality of design validation devices configured to receive the design data from the computing device and perform a simulation process to validate at least one of a plurality of product characteristics calculated from the design data;
the computing device configured to determine the allocation of the design data to at least one of the plurality of design validation devices according to a workload of each of the plurality of design validation devices; and
the workload is determined based on simulation processes currently being performed or standing by in queues of each of the plurality of respective design validation devices.

16. A design validation device, comprising:
a data receiver configured to receive from at least one external device design information indicating a product design drawing and simulation information indicating at least one product characteristic to be validated;
a data transmitter configured to transmit workload information related to the device's current workload to the external device; and
a simulation calculator configured to generate validation results based on the design information and the simulation information and to store the validation results in a memory.

17. The design validation device of claim 16, wherein
the simulation information received from the external device includes a simulation process for virtually validating the at least one product characteristic; and
the simulation calculator is configured to generate the validation results by compiling and executing the simulation process and using the simulation process to virtual validate the device design information.

18. The design validation device of claim 17, wherein the data transmitter is configured to transmit the generated validation results to the external device.

19. The design validation device of claim 16, further comprising:
a data converter configured to convert the received design information into a file format compatible with the simulation calculator.

20. The design validation device of claim 16, wherein the data receiver is configured to receive additional design information and simulation information from the external device in response to the transmitted workload information.
